(19) United States
(12) Patent Application Publication
(10) Pub. No.: US 2025/0269875 A1
(43) Pub. Date: Aug. 28, 2025

(54) VEHICLE CONTROL METHOD AND DEVICE

(71) Applicants: HYUNDAI MOTOR COMPANY, Seoul (KR); KIA CORPORATION, Seoul (KR); CHUNG ANG UNIVERSITY INDUSTRY ACADEMIC COOPERATION FOUNDATION, Seoul (KR)

(72) Inventors: Sung Woo Choi, Hwaseong-si (KR); Su Young Choi, Hwaseong-si (KR); Su Jin Han, Hwaseong-si (KR); Sung Kwan Kim, Hwaseong-si (KR); Sang Ho Yoon, Bucheon-si (KR); Jae Sung Ryou, Seoul (KR); Kyung Jae Lee, Seoul (KR)

(73) Assignees: HYUNDAI MOTOR COMPANY, Seoul (KR); KIA CORPORATION, Seoul (KR); CHUNG ANG UNIVERSITY INDUSTRY ACADEMIC COOPERATION FOUNDATION, Seoul (KR)

(21) Appl. No.: 18/886,543

(22) Filed: Sep. 16, 2024

(30) Foreign Application Priority Data
Feb. 27, 2024 (KR) 10-2024-0028244

(51) Int. Cl. B60W 60/00; G01C 21/34

(52) U.S. Cl. CPC B60W 60/0011; G01C 21/3446

(57) ABSTRACT

A method for controlling an autonomous vehicle includes: calculating a first reward corresponding to at least a portion of first driving path information based on a result of performing a driving simulation according to the first driving path information; training a driving path generation network based on at least a portion of the first reward; generating at least one second driving path information corresponding to second state information through the driving path generation network; calculating a second reward corresponding to at least a portion of the second driving path information based on a result of performing a driving simulation according to the second driving path information; training the driving path generation network based on at least a portion of the second reward; generating test driving path information corresponding to test state information through the trained driving path generation network; and controlling the autonomous vehicle.

### CROSS-REFERENCE TO RELATED APPLICATION

This application claims the benefit of and priority to Korean Patent Application No. 10-2024-0028244, filed in the Korean Intellectual Property Office on Feb. 27, 2024, the entire contents of which are incorporated herein by reference.

### TECHNICAL FIELD

The present disclosure relates to a vehicle control method and a vehicle control device.

### BACKGROUND

For smooth autonomous driving, it is necessary for a host vehicle to quickly derive a driving path along which driving is performed safely without colliding with obstacles around the host vehicle in response to a driving situation around the host vehicle.

In particular, considering the characteristics of urban areas where many obstacles (e.g., nearby vehicles) are located around the host vehicle, it is required to quickly and accurately generate a driving path. Also, considering interaction with a number of nearby vehicles located around the host vehicle, it is required to support a host vehicle to change lanes or drive in free space safely.

Accordingly, methods for generating driving paths are being studied.

### SUMMARY

The present disclosure has been made to solve the above-mentioned problems occurring in the prior art while advantages achieved by the prior art are maintained intact.

Aspects of the present disclosure provide a vehicle control method and a vehicle control device.

Aspects of the present disclosure provide a training method and a training device for generating a driving path and provide a testing method and a testing device using the same.

Aspects of the present disclosure provide a training method and a training device for generating a driving path based on reinforcement learning and provide a testing method and a testing method device using the same.

Aspects of the present disclosure provide a training method and a training device for generating a driving path in response to various driving scenarios and provide a testing method and a testing method device using the same.

Aspects of the present disclosure provide a training method and a training device for generating an accurate driving path within a short calculation time in a vehicle with limited computational resources and provide a test method and a test device using the same.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, a method for controlling an autonomous vehicle is provided. The method includes, in response to a determination that a plurality of first driving path information corresponding to first state information is acquired, calculating a first reward corresponding to at least a portion of the first driving path information based on a result of performing a driving simulation according to the first driving path information, and training a driving path generation network based on at least a portion of the first reward. The method also includes, in response to a determination that second state information is acquired, generating at least one second driving path information corresponding to the second state information through the driving path generation network, calculating a second reward corresponding to at least a portion of the second driving path information based on a result of performing a driving simulation according to the second driving path information, and training the driving path generation network based on at least a portion of the second reward. The method also includes, in response to a determination that test state information is acquired, generating test driving path information corresponding to the test state information through the trained driving path generation network, and controlling the autonomous vehicle using the test driving path information.

According to an embodiment, calculating the first reward may include generating the first driving path information corresponding to the first state information based on road information on a Frenet frame. Calculating the first reward may also include generating first mapping driving path information by mapping the first driving path information to a Cartesian frame. Calculating the first reward may also include calculating the first reward corresponding to first driving path information on the Frenet frame that has been mapped to the first mapping driving path information on the Cartesian frame based on a result of performing a driving simulation according to the first mapping driving path information.

According to an embodiment, calculating the first reward may include mapping the first driving path information to the Cartesian frame by referring to curvature information contained in the road information.

According to an embodiment, calculating the second reward may include generating, by the driving path generation network, an amount of change in position of a point corresponding to each of a plurality of time steps included in a unit time period as the second driving path information.

According to an embodiment, calculating the second reward may include generating the second driving path information corresponding to the second state information based on road information on a Frenet frame. Calculating the second reward may also include generating second mapping driving path information by mapping the second driving path information to a Cartesian frame. Calculating the second reward may also include calculating the second reward corresponding to second driving path information on the Frenet frame that has been mapped to the second mapping driving path information on the Cartesian frame based on a result of performing a driving simulation according to the second mapping driving path information.

According to an embodiment, calculating the second reward may include mapping the second driving path information to the Cartesian frame by referring to curvature information contained in the road information.

According to an embodiment, the driving path generation network may include a classifier configured to determine a driving scenario corresponding to a current driving situation of a host vehicle among a first driving scenario to an n-th driving scenario based on at least a portion of input data including the first state information and the second state information. The driving path generation network may also include a first driving path generation network to an n-th driving path generation network respectively corresponding to the first driving scenario to the n-th driving scenario. The method may also include determining, by the classifier, a k-th driving scenario corresponding to the current driving situation of the host vehicle based on at least a portion of the input data. The method may also include training a k-th driving path generation network corresponding to the k-th driving scenario based on a (1_k)-th reward according to (1_k)-th driving path information corresponding to the k-th driving scenario among the first driving path information, and based on a (2_k)-th reward according to (2_k)-th driving path information corresponding to the k-th driving scenario among the second driving path information.

According to an embodiment, at least a portion of the first driving path information may be a Gaussian random path.

According to an aspect of the present disclosure, a device for controlling an autonomous vehicle is disclosed. The device includes a memory that may store computer-executable instructions and at least one processor configured to access the memory and execute the computer-executable instructions. The at least one processor may, in response to a determination that a plurality of first driving path information corresponding to first state information is acquired, calculate a first reward corresponding to at least a portion of the first driving path information based on a result of performing a driving simulation according to the first driving path information and train the driving path generation network based on at least a portion of the first reward. The at least one processor may, in response to a determination that second state information is acquired, generate at least one second driving path information corresponding to the second state information through the driving path generation network, calculate a second reward corresponding to at least a portion of the second driving path information based on a result of performing a driving simulation according to the second driving path information, and train a driving path generation network based on at least a portion of the second reward. The at least one processor may, in response to a determination that test state information is acquired, generate test driving path information corresponding to the test state information through the trained driving path generation network and control the autonomous vehicle using the test driving path information.

According to an embodiment, the at least one processor may generate the first driving path information corresponding to the first state information based on road information on a Frenet frame. The at least one processor may generate first mapping driving path information by mapping the first driving path information to a Cartesian frame. The at least one processor may calculate the first reward corresponding to first driving path information on the Frenet frame that has been mapped to the first mapping driving path information on the Cartesian frame based on a result of performing a driving simulation according to the first mapping driving path information.

According to an embodiment, the at least one processor may map the first driving path information to the Cartesian frame by referring to curvature information contained in the road information.

According to an embodiment, the at least one processor may generate, through the driving path generation network, an amount of change in position of a point corresponding to each of a plurality of time steps included in a unit time period as the second driving path information.

According to an embodiment, the at least one processor may generate the second driving path information corresponding to the second state information based on road information on a Frenet frame. The at least one processor may also generate second mapping driving path information by mapping the second driving path information to a Cartesian frame. The at least one processor may also calculate the second reward corresponding to second driving path information on the Frenet frame that has been mapped to the second mapping driving path information on the Cartesian frame based on a result of performing a driving simulation according to the second mapping driving path information.

According to an embodiment, the at least one processor may map the second driving path information to the Cartesian frame by referring to curvature information contained in the road information.

According to an embodiment, the driving path generation network may include a classifier configured to determine a driving scenario corresponding to a current driving situation of a host vehicle among a first driving scenario to an n-th driving scenario based on at least a portion of input data including the first state information and the second state information. The driving path generation network may also include a first driving path generation network to an n-th driving path generation network respectively corresponding to the first driving scenario to the n-th driving scenario. The at least one processor may determine, through the classifier, a k-th driving scenario corresponding to the current driving situation of the host vehicle based on at least a portion of the input data. The at least one processor may also train the k-th driving path generation network corresponding to the k-th driving scenario based on a (1_k)-th reward according to (1_k)-th driving path information corresponding to the k-th driving scenario among the first driving path information, and based on a (2_k)-th reward according to (2_k)-th driving path information corresponding to the k-th driving scenario among the second driving path information.

According to an embodiment, at least a portion of the first driving path information may be a Gaussian random path.

### BRIEF DESCRIPTION OF THE DRAWINGS

The above and other objects, features, and advantages of the present disclosure should be more apparent from the following detailed description taken in conjunction with the accompanying drawings:

FIG. 1 is a flowchart for describing a training method for generating a driving path according to an embodiment of the present disclosure;

FIGS. 2A and 2B are diagrams schematically showing a plurality of first driving path information generated according to an embodiment of the present disclosure;

FIGS. 3A, 3B, 3C, and 3D are diagrams schematically showing road information on a Cartesian frame and driving path information on a Frenet frame;

FIG. 4 is a flowchart for describing a process for training a driving path generation network that generates driving paths, according to one embodiment of the present disclosure;

FIGS. 5A and 5B are diagrams showing a driving path generation network corresponding to each driving scenario according to an embodiment of the present disclosure;

FIGS. 6A, 6B, 6C, and 7 are diagrams illustrating a training process for each driving scenario according to an embodiment of the present disclosure;

FIG. 8 is a flowchart for describing a process for training a driving path generation network that generates driving paths, according to one embodiment of the present disclosure;

FIG. 9 is a block diagram illustrating a device for generating a driving path according to an embodiment of the present disclosure;

FIG. 10 is a diagram illustrating a testing process for generating driving paths according to an embodiment of the present disclosure;

FIGS. 11A and 11B are diagrams schematically illustrating driving path information output by a driving path generation network trained according to a training method according to an embodiment of the present disclosure; and

FIG. 12 is a block diagram of a computing system related to a vehicle control method and device according to an embodiment of the present disclosure.

In the description of the drawings, the same or similar reference numerals may be used for the same or similar components.

### DETAILED DESCRIPTION

Hereinafter, some embodiments of the present disclosure are described in detail with reference to the drawings. It should be noted that identical or equivalent components are designated by identical numerals even if the components are displayed on different drawings. Further, in describing the embodiments of the present disclosure, a detailed description of well-known features or functions has been omitted in order not to unnecessarily obscure the gist of the present disclosure. Hereinafter, various embodiments of the present disclosure may be described with reference to accompanying drawings. However, this is not intended to limit the technology described herein to specific embodiments. Those of ordinary skill in the art should recognize that modifications, equivalents, or alternatives on the various embodiments described herein may be variously made without departing from the scope and spirit of the disclosure. With regard to description of drawings, similar components may be marked by similar reference numerals.

In describing the components of the embodiment according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings consistent with the contextual meanings in the relevant field of art. Such terms should not be interpreted as having ideal or excessively formal meanings unless clearly defined as having such in the present application. For example, the terms, such as “first”, “second”, and the like, used in the disclosure may be used to refer to various components regardless of the order or the priority and to distinguish the relevant components from other components and do not limit the components. For example, “a first user device” and “a second user device” indicate different user devices regardless of the order or priority. For example, without departing the scope of the disclosure, a first component may be referred to as a second component, and similarly, a second component may be referred to as a first component.

In the disclosure, the expressions “have”, “may have”, “include”, “comprise”, “may include”, and “may comprise” used herein indicate existence of corresponding features (e.g., components, such as numeric values, functions, operations, or parts) and do not exclude presence of additional features.

It should be understood that, if a component (e.g., a first component) is referred to as being “(operatively or communicatively) coupled with/to” or “connected to” another component (e.g., a second component), the component may be directly coupled with/to or connected to the other component or an intervening component (e.g., a third component) may be present. In contrast, if a component (e.g., a first component) is referred to as being “directly coupled with/to” or “directly connected to” another component (e.g., a second component), it should be understood that there is no intervening component (e.g., a third component).

According to the situation, the expression “configured to” used in the disclosure may be used as, for example, the expression “suitable for”, “having the capacity to”, “designed to”, “adapted to”, “made to”, or “capable of”. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The term “configured to (or set to)” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor), which performs corresponding operations by executing one or more software programs stored in a memory device. Terms used in the present disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person having ordinary skill in the art. It should be further understood that terms, which are defined in a dictionary and commonly used, should also be interpreted as is customary in the relevant related art. The terms should not be interpreted in an idealized or overly formal unless expressly so defined in various embodiments of the present disclosure. In some cases, even if terms are defined in the disclosure, the terms may not be interpreted to exclude embodiments of the present disclosure.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. In describing components of embodiments of the present disclosure, each of the phrases “A or B,” “at least one of A and B,” “at least one of A or B,” “A, B or C,” “at least one of A, B and C,” “at least one of A, B, or C” and “at least one of A, B, C, or any combination thereof” may include any one of items listed along with a relevant phrase, or any possible combination thereof. In particular, phrases such as “at least one of A, B, C, or any combination thereof” may include A, B, C, or a combination thereof such as AB, ABC, or the like.

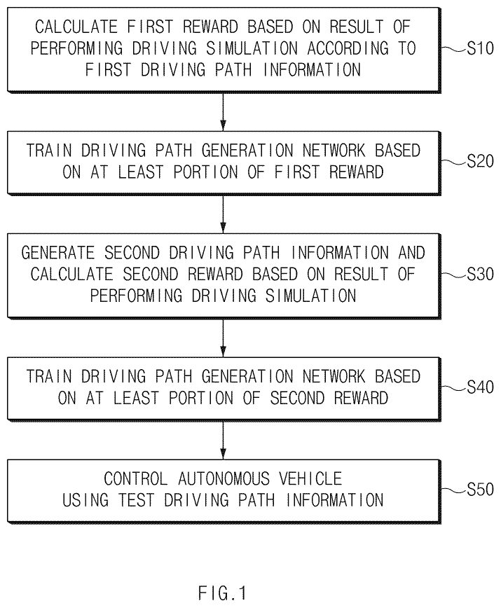

Embodiments of the present disclosure are described below in detail with reference to FIGS. 1-12.

FIG. 1 is a flowchart illustrating a training method for generating a driving path according to an embodiment of the present disclosure.

First, if a plurality of first driving path information corresponding to first state information is obtained, a first reward corresponding to at least a portion of the first driving path information may be calculated based on the result of performing a driving simulation according to the first driving path information (S10).

For reference, the first state information, the first driving path information, and first reward are used in the initial training phase of a driving path generation network. In addition, if the performance of the driving path generation network reaches a certain level through initial training, training (i.e., fine tuning) for the driving path generation network may be performed based on second state information, second driving path information, and second reward, which is described below.

In addition, the first state information and the second state information may include information about the speed and the heading of a host vehicle, information about the locations, the headings or the like of vehicles located around the host vehicle, and information about the curvature of a road or the like, which is described in detail below.

Furthermore, at least a portion of the first driving path information may be generated and acquired based on a Gaussian random path.

As an example, the path may be sampled based on Gaussian Process Regression (GPR). Based on Gaussian process regression, a curve that smoothly connects given points, such as a B-spline, may be acquired, and a covariance matrix may be acquired. Additionally, based on Gaussian process regression, a sampled path may be expressed as a smooth curve.

In addition, a path based on Gaussian process regression (i.e., Gaussian Random Path; GRP) may be modeled through a function that takes time as input and returns two-dimensional (2D) coordinates as output.

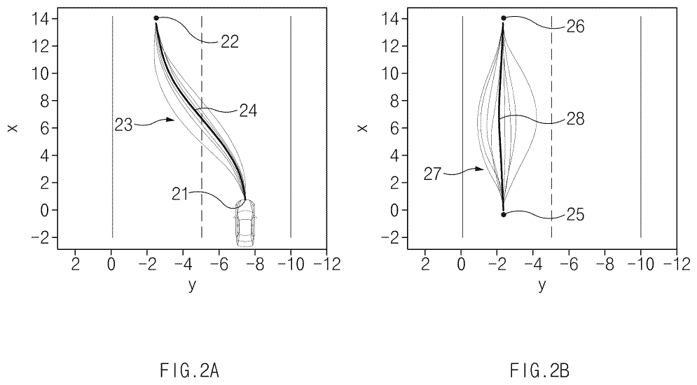

FIG. 2 is a diagram schematically showing a plurality of first driving path information generated according to an embodiment of the present disclosure.

First, referring to FIG. 2A illustrating a plurality of first driving path information corresponding to a lane change scenario, it may be seen that there is a plurality of first driving path information including “N” waypoints corresponding to a time period “T”, which includes a starting waypoint 21 and an ending waypoint 22.

For example, the plurality of first driving path information may include a plurality of Gaussian random paths 23 but is not limited thereto. For example, as shown in FIG. 2A, the plurality of Gaussian random paths 23 may be generated, and a mean path 24 calculated based on the plurality of Gaussian random paths 23 may also be included in the plurality of first driving paths.

Furthermore, referring to FIG. 2B illustrating a plurality of first driving path information corresponding to a free space driving scenario, it may be seen that there is a plurality of first driving path information including “N” waypoints corresponding to the time period “T”, which includes a starting waypoint 25 and an ending waypoint 26.

For example, the plurality of first driving path information may include a plurality of Gaussian random paths 27 but is not limited thereto. For example, as shown in FIG. 2B, the plurality of Gaussian random paths 27 may be generated, and a mean path 28 calculated based on the plurality of Gaussian random paths 27 may also be included in the plurality of first driving paths.

For reference, as described above, each of the plurality of first driving path information may include “N” waypoints (including starting and ending points) corresponding to “N” time steps within the time period “T”, an example of which is shown in Table 1 below.

TABLE 1

| Time steps | −δ | 0 | t₁ | t₂ | . . . | t_{N-1} = T | T + δ |
|---|---|---|---|---|---|---|---|
| Waypoints | xₛ − εcosθₛ | xₛ | x₁ | x₂ | . . . | x_{N-1} | x_{N-1} + εcosθ_{g} |
| | yₛ − εsinθₛ | yₛ | y₁ | y₂ | . . . | y_{N-1} | y_{N-1} + εsinθ_{g} |

In this case, to additionally consider information about the headings of the host vehicle at the starting/ending waypoints, the slope of the path may be additionally controlled by adding virtual points before and after the “N” waypoints.

For example, as shown in Table 1, a point (xₛ-ε cos θₛ, yₛ-ε sin θₛ) corresponding to time step −δ may be added a distance E before the starting point corresponding to time step 0, and a point (x_{N-1}+ε cos θ_{g}, y_{N-1}+ε sin θ_{g}) corresponding to time step T+8 corresponding to time step T+δ may be added the distance & after the ending point corresponding to time step T. For reference, θₛ corresponds to the angle of ε at the starting waypoint, and θ_{g} corresponds to the angle of ε at the ending waypoint.

In this case, the first driving path information and the second driving path information, which is described below, may be generated on a Frenet frame.

Specifically, road information on a Cartesian frame may be converted into road information on a Frenet frame, and driving path information may be generated based on the road information on the Frenet frame. For reference, a road on the Frenet frame may be a road obtained by straightening a curved road on a Cartesian frame.

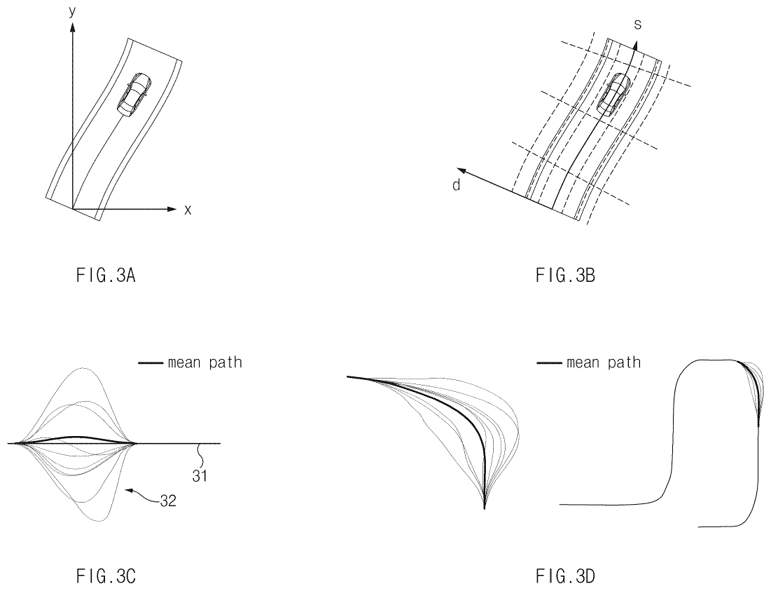

FIGS. 3A, 3B, 3C, and 3D are diagrams schematically showing road information on a Cartesian frame and driving path information on a Frenet frame.

First, referring to FIG. 3A illustrating road information on a Cartesian frame, it may be seen that there is information about curved roads according to the actual road shape. On the other hand, referring to FIG. 3B showing information about roads on a Frenet frame, it may be seen that road information in the form of a straight line is shown at regular time points (s=0, S=10, s=25, s=40) by converting the road information on the Cartesian frame into road information on a Frenet frame.

Additionally, referring to FIG. 3C illustrating the driving path information on the Frenet frame, it may be seen that a plurality of driving path information 32 is generated on a straight road 31. On the other hand, referring to FIG. 3D illustrating the driving path information on the Cartesian frame, it may be seen that the driving path information is generated on curved roads according to actual road shapes.

If driving path information is generated based on road information on the Frenet frame, the driving path information may be expressed as a straight driving path regardless of the actual shape of the road (e.g., curved shape). Thus, training the driving path generation network in a state where all roads are straightened from the perspective of the driving path generation network may be performed to achieve efficient training.

In this case, to enable training on road sections, which are curved, state information (e.g., first state information or second state information) may include curvature information.

For example, first driving path information (e.g., a plurality of Gaussian random paths (GRP) and the mean path) corresponding to the first state information may be generated based on road information on the Frenet frame.

Additionally, the first mapping driving path information may be generated by mapping the first driving path information to a Cartesian frame.

In this case, the waypoints on the first driving path information may be rotated (or moved) by referring to the curvature information (or the angle value of the road) included in the road information, and then the first driving path information may be mapped to the Cartesian frame.

Further, a first reward corresponding to the specific first driving path information on the Frenet frame mapped to the specific first mapping driving path information on the Cartesian frame may be calculated based on the result of performing a driving simulation according to the first mapping driving path information.

For example, based on the result of performing a driving simulation according to a plurality of first mapping driving path information (i.e., driving path information on the Cartesian frame), among a plurality of first mapping driving path information, a specific first mapping driving path information in which driving is successful (e.g., does not collide with an obstacle) may be converted to driving path information on the frenet frame (i.e., the specific first driving path information). The specific first driving path information and a relevant state may be stored. If driving has been completed, a corresponding reward (e.g., first reward) may be calculated.

If the first reward is calculated in S10, the driving path generation network may be trained based on at least a portion of the first reward (S20).

For example, the driving path generation network may be trained based on cross entropy optimization.

For example, among paths in which driving is successful based on the first reward (e.g., specific first driving path information), specific first driving path information of top p % having a relatively high reward may be determined. The top p % or top “n” of points of the specific first driving path information may be grouped by “k” number and stored in a replay buffer. A process of training the driving path generation network based on the data stored in the replay buffer may be repeatedly performed.

For reference, number “k” may be the number of sampling iterations for driving path generation. For example, grouping the top p % of points of the specific first driving path information into 10 points and storing the top p % of points of the specific first driving path information in the replay buffer may mean that driving is performed along the 10 points and sampling is then performed to generate the driving path again.

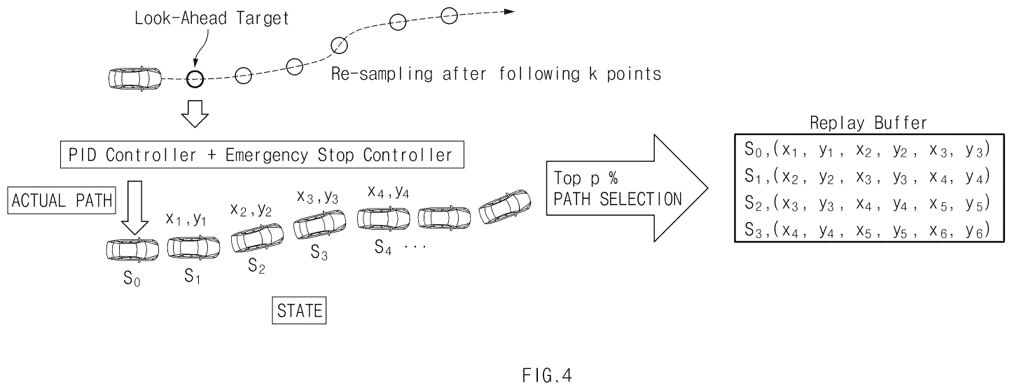

As an example, referring to FIG. 4, after first driving path information (e.g., 10 pieces of driving path information generated by a Gaussian random path and one mean path corresponding thereto) has been generated, driving may be performed along a path by using a lateral controller (e.g., a PID controller or Stanley controller), a speed obtained by differentiating the driving path, and a longitudinal controller (for example, an emergency stop controller). Furthermore, paths in which driving is successful may be converted back to paths in the Frenet frame, the converted paths and the relevant states (S0, S1, S2, S3, S4, . . . ) may be stored. If the driving has been completed, rewards may be calculated, and then a path with the highest reward may be selected based on the cross entropy method. For reference, in FIG. 4, for convenience of description, a path may be newly sampled each time driving for 3 points is completed, and 3 points may be grouped for each state and stored in the replay buffer but is not limited thereto.

As another example, all paths in which driving is successful (e.g., specific first driving path information) may be stored in a replay buffer, and the driving path generation network may be trained based on the paths.

Meanwhile, the driving path generation network may include a network corresponding to each driving scenario.

As an example, the driving path generation network may include (i) a classifier for determining a driving scenario based on at least a portion of the state information, and (ii) a first driving path generation network to an n-th driving path generation network for generating driving path information for each driving scenario determined according to a result of classification by the classifier.

In this case, the classifier may determine a specific driving scenario corresponding to the current driving situation of the host vehicle among the first to n-th driving scenarios based on at least a portion of input data including the first state information and the second state information. Further, the classifier may be in a pre-trained state but is not limited thereto.

In addition, each of the first to n-th driving path generation networks may correspond to the first to n-th driving scenarios, respectively.

For example, if the first driving scenario is a lane change scenario and the second driving scenario is a free space driving scenario, the first driving path generation network may generate driving path information corresponding to the lane changing scenario, and the second driving path generation network may generate driving path information corresponding to the free space driving scenario.

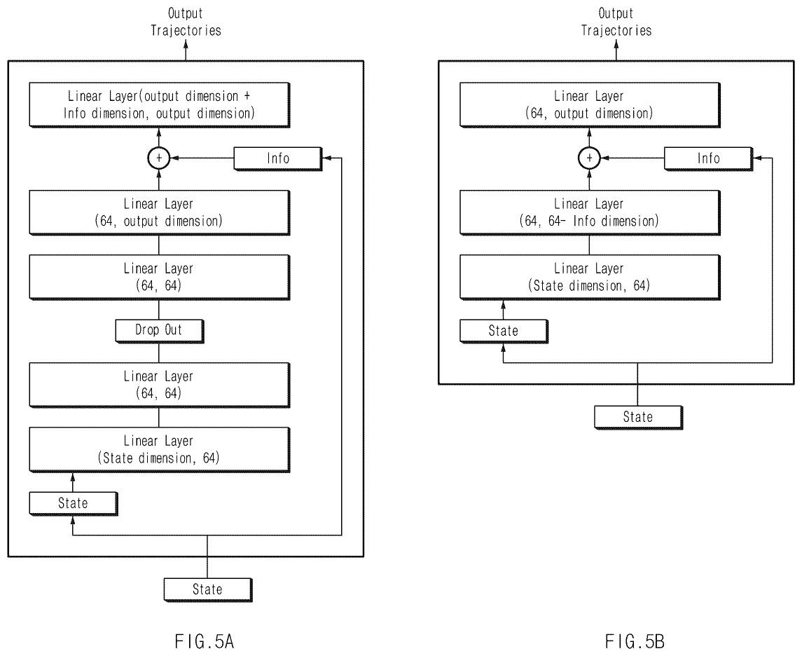

FIGS. 5A and 5B are illustrate a driving path generation network corresponding to each driving scenario. Specifically, FIG. 5A illustrates an example structure of a driving path generation network corresponding to a lane change scenario, and FIG. 5B illustrates an example structure of a driving path generation network corresponding to a free space driving scenario. Referring to FIGS. 5A and 5B, it may be seen that curvature information and speed information (Info; information feature) among state information (State) are input just before the last layer of each network. This is to ensure that the curvature information has a greater impact on the output of the network (i.e., driving path information). In other words, the purpose is to output an appropriate driving path even for curved roads.

For example, if a classifier determines a k-th driving scenario corresponding to the current driving situation of a host vehicle based on at least a portion of input data, a k-th driving path generation network corresponding to the k-th driving scenario may generate a (1_k)-th driving path information, which is first driving path information corresponding to the k-th driving scenario, and may be trained based on a (1_k)-th reward corresponding thereto. Furthermore, as described below, the k-th driving path generation network may generate a (2_k)-th driving path information, which is second driving path information corresponding to the k-th driving scenario and may be trained based on a (2_k)-th reward corresponding thereto.

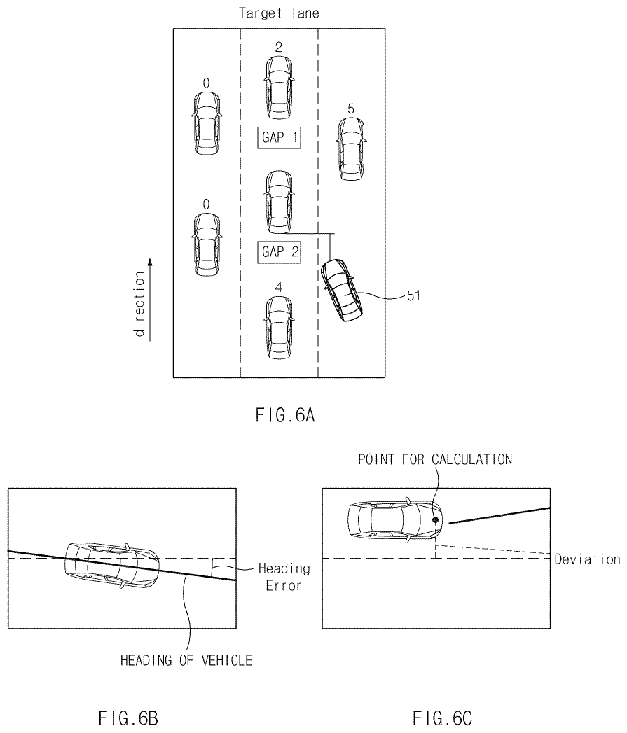

First, a training process for a lane change scenario is described with reference to FIGS. 6A, 6B, and 6C.

For example, as shown in FIG. 6A, if the goal of the host vehicle (i.e., agent; 51) is to change lanes to the space in front (GAP1) or the space behind (GAP2) of a vehicle with car number 3, in the initial phase, detailed driving scenarios (e.g., a scenario where the host vehicle changes lanes after temporal stop or a scenario where the host vehicle changes lanes without temporal stop), state information about the driving styles of nearby vehicles, or the like may be set. Additionally, various driving paths may be attempted for the host vehicle to change lanes in front or behind the vehicle with car number 3. In addition, coordinates corresponding to the trajectories of the host vehicle along the corresponding driving paths may be stored (which may be repeatedly performed for all driving path information generated). Furthermore, the driving path with the highest reward (or top p % reward) may be stored in a memory. If the current memory size is greater than or equal to a batch size, training may be performed on all data stored in the memory.

For reference, in FIG. 6A, the host vehicle 51 may be a model corresponding to a lane change scenario, while the nearby vehicles may be models corresponding to a lane maintenance (or free space driving) scenario.

For example, the state information may include agent feature information, other car feature information, and information feature information.

Here, the agent feature information may include (i) heading error of the host vehicle, (ii) deviation of the host vehicle, and (iii) a distance to a vehicle in front of the host vehicle. In this case, the heading error of the host vehicle may be the angle between the heading of the host vehicle and the driving path, as shown in FIG. 6B. Furthermore, the deviation of the host vehicle may be the shortest distance between a specific part of the host vehicle and the driving path (or the center of the host lane), as shown in FIG. 6C.

In addition, the other car feature information may include (i) the speed of a nearby vehicle, (ii) a distance between the nearby vehicle and the host vehicle (Ax and Ay), (iii) the heading error of the nearby vehicle (e.g., a difference between the heading of the nearby vehicle and the heading of the host vehicle), and (iv) the deviation of the nearby vehicle (e.g., the shortest distance between the specific part of the nearby vehicle and the driving path).

Additionally, the information feature information may include (i) the curvature of a road at the current location of the host vehicle, (ii) the curvature of a road 15 meters ahead of the current location, and (iii) the current speed of the host vehicle.

For example, compensation (reward) in the lane change scenario may be calculated by the following factors.
Collision: −500 if there is a collision, 0 otherwise
Success: 0 if there is a collision, 400 otherwise
Path: −10*(the sum of deviations of the host vehicle while driving/driving distance)
Gap: 0 if the host vehicle enters an appropriate space in consideration of the driving style of a target nearby vehicle (e.g., vehicle with car number 3), −200 otherwise
Time: (a predetermined driving time−actual driving time)*10
Pose: −10*(heading error if the center of a target lane is reached)

For example, a driving style for each driving scenario and an appropriate space in which the host vehicle 51 is to change lanes toward nearby vehicles may be as shown in Table 2.

TABLE 2

| Driving | | | Appropriate |
|---|---|---|---|
| style | Lane change | Lane maintenance | space (Gap) |
| Aggressive | Change more | Decreasing | Gap 2 |
| | rapidly than | distance from | |
| | default value | vehicle in front | |
| Neutral | Default value | Maintaining | Gap 2 |
| | | distance from | |
| | | vehicle in front | |
| Passive | Change more slowly | Increasing | Gap 1 |
| | than default value | distance from | |
| | | vehicle in front | |

For example, in the lane change scenario of FIG. 6A, because the vehicle with car number 3 tends to decrease the distance from a vehicle (with car number 2) in front of the vehicle with car number 3 if the driving style of the vehicle with car number 3, which is maintaining the lane, is aggressive, the action of changing lanes to a space (Gap 2) behind the vehicle with car number 3 for safety may be rewarded the most.

On the other hand, for example, in the lane change scenario of FIG. 6A, because the vehicle with car number 3 tends to increase the distance from a vehicle (with car number 2) in front of the vehicle with car number 3 if the driving style of the vehicle with car number 3, which is maintaining the lane, is passive, the action of changing lanes to a space (Gap 1) in front of the vehicle with car number 3 for safety may be rewarded the most.

For reference, six driving models are described in Table 2 above for ease of description but is not limited thereto.

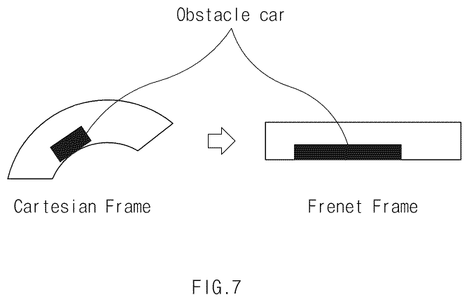

Next, a process for training a free-space driving scenario is described with reference to FIG. 7.

For example, if the goal of the host vehicle is to drive without collision by avoiding stationary vehicle, state information such as the poses and number (e.g., 1 to 4) of host vehicles (agents) and nearby vehicles (obstacles), or the like may be set in an initial phase. Then, driving may be performed by a PID controller according to first driving path information (e.g., a plurality of Gaussian random paths and a mean path). The coordinates corresponding to the trajectories along which the host vehicle driven according to corresponding driving paths may be stored (which may be repeatedly performed for all path information generated). Furthermore, the driving path with the highest reward (or top p % reward) may be stored in a memory. If the current memory size is greater than or equal to a batch size, training may be performed on all data stored in the memory.

For example, the state information may include agent feature information, other car feature information, and information feature information.

Here, the agent feature information may include (i) heading error of the host vehicle, (ii) deviation of the host vehicle, and (iii) a distance to a vehicle in front of the host vehicle. The lane change scenario of the host vehicle is the same/similar to that described above, and therefore, the redundant description has been omitted.

In addition, the other car feature information may include (i) a distance between the nearby vehicle and the host vehicle (Δx and Δy), (ii) the heading error of the nearby vehicle (e.g., a difference between the heading of the nearby vehicle and the heading of the host vehicle), (iii) the deviation of the nearby vehicle (e.g., the shortest distance between the specific part of the nearby vehicle and the driving path), and (iv) the length of a nearby vehicle in a Frenet frame.

In this case, the length of the nearby vehicle in the Frenet frame may be the length occupied by the nearby vehicle (obstacle car) if converted from the Cartesian frame to the Frenet frame, as shown in FIG. 7.

Additionally, the information feature information may include (i) the curvature of a road at the current location of the host vehicle, (ii) the curvature of a road 15 meters ahead of the current location, and (iii) the current speed of the host vehicle.

For example, compensation (reward) in the free-space driving scenario may be calculated by the following factors.
Collision: −500 if there is a collision, 0 otherwise
Success: 0 if there is a collision, 400 otherwise
Path: −10*(the sum of deviations from paths while host vehicle is driving/driving distance)
Deviation: (sum of deviations from the center of a road while host vehicle is driving)/driving distance
Time: 10*(distance from obstacle if host vehicle is being in the same lane as obstacle)

For reference, descriptions that overlap with those described in relation to the lane change scenario have been omitted.

After the driving path generation network has been trained based on at least a portion of the first reward in S20, a process for finely tuning the driving path generation network may be performed as a later training phase.

In other words, in the above-described initial training phase, the driving path generation network has been trained using driving path information (i.e., first driving path information) based on a Gaussian random path. In the later training phase, the driving path generation network may be trained based on driving path information directly output by the driving path generation network, which has been trained to a certain level.

For example, if second state information is acquired, at least one second driving path information corresponding to the second state information may be generated through the driving path generation network, and a second reward corresponding to at least a portion of the second driving path information may be calculated based on the result of performing a driving simulation according to the second driving path information (S30).

For example, the second driving path information corresponding to the second state information may be generated based on road information on the Frenet Frame. A second mapping driving path information may be generated by mapping the second driving path information to the Cartesian frame. A second reward corresponding to specific second driving path information on the Frenet frame that has been mapped to the specific second mapping driving path information on the Cartesian frame may be calculated based on the result of performing a driving simulation according to the second mapping driving path information.

In this case, the second driving path information may be mapped to the Cartesian frame by referring to curvature information contained in road information.

For reference, the mapping and conversion between the Frenet frame and the Cartesian frame are the same/similar to those which have been described with respect to the initial training phase, and therefore, the redundant description has been omitted.

On the other hand, the driving path generation network does not learn the coordinate values of points in the driving path information, but rather the amount of change in coordinates. This may allow the output value to be added to the current position of the host vehicle (agent) to generate driving path information corresponding to the current state.

For example, the driving path generation network may generate, as second driving path information, the amount of change in the position of a point corresponding to each of a plurality of time steps included in a unit time period “T”.

As described above, the driving path generation network may include (i) a classifier for determining a driving scenario, and (ii) a first driving path generation network to an n-th driving path generation network for generating driving path information for each driving scenario in response to a result of classification by the classifier.

For example, if a classifier determines a k-th driving scenario corresponding to the current driving situation of a host vehicle based on at least a portion of input data, a k-th driving path generation network corresponding to the k-th driving scenario may generate a (2_k)-th driving path information, which is second driving path information corresponding to the k-th driving scenario, and may be trained based on a (2_k)-th reward corresponding thereto.

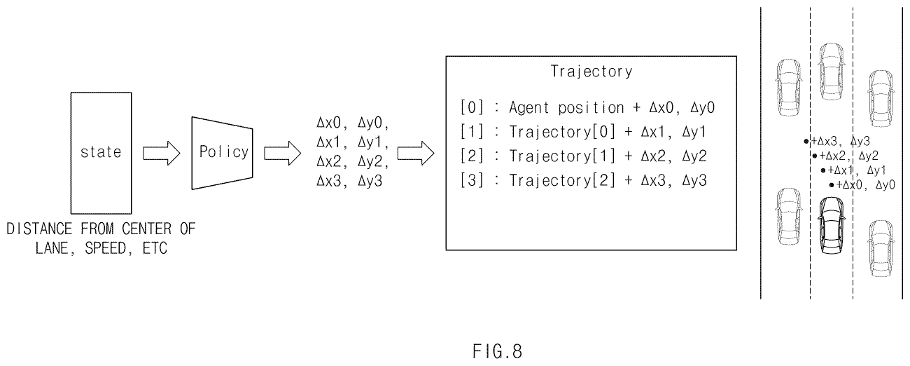

Referring to FIG. 8, it may be seen that, if second state information (state; the distance of the host vehicle away from the center of the lane, the speed of the host vehicle, or the like) is acquired, the driving path generation network may identify that the amount of change in position of a point corresponding to each of the plurality of time steps is generated as the second driving path information based on a policy.

FIG. 8 illustrates the eight amounts of change in points (four amounts of x-axis change and four amounts of Y-axis change) for four points, but this is for illustrative purposes only and is not limited thereto.

If a second reward is calculated according to S30, the driving path generation network may be trained based on at least a portion of the second reward (S40).

If test state information for reference is acquired after the driving path generation network has been trained according to S40, test driving path information corresponding to the test state information may be generated (inferred) through the trained driving path generation network. Also, the test driving path information may be used to control an autonomous vehicle (S50).

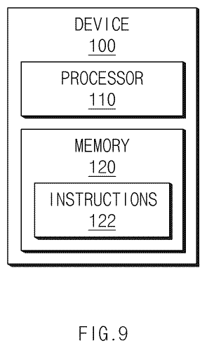

FIG. 9 is a block diagram illustrating a device for generating a driving path according to an embodiment disclosed herein.

Referring to FIG. 9, a device 100 for generating a driving path may include a memory 120 that stores computer-executable instructions and may include at least one processor 110 that accesses the memory 120 to execute instructions 122.

If a plurality of first driving path information corresponding to first state information is obtained, the processor 110 may calculate a first reward corresponding to at least a portion of the first driving path information based on the result of performing a driving simulation according to the first driving path information.

Then, the processor 110 may train a driving path generation network based on at least a portion of the first reward.

If second state information is acquired, the processor 110 may generate at least one second driving path information corresponding to the second state information through the driving path generation network. The processor 110 may also calculate a second reward corresponding to at least a portion of the second driving path information based on the result of performing a driving simulation according to the second driving path information (S30).

Then, the processor 110 may train the driving path generation network based on at least a portion of the second reward.

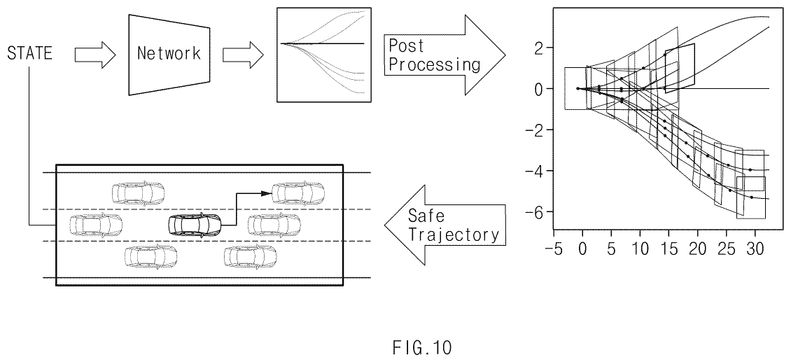

Hereinafter, a test method is described in more detail with reference to FIG. 10.

FIG. 10 is a diagram illustrating a test process for generating a driving path as disclosed herein.

First, if state information (State) is input to the driving path generation network that generates a driving path (Local Trajectory) for a given time “T”, a test device may classify a current driving scenario of a host vehicle based on the state information through a classifier. The test device may also generate driving path information through the driving path generation network corresponding to the classified driving scenario. For reference, the generated driving path information may be sub-optimal driving path information.

In addition, for the generated driving path information, post-processing to calculate a collision or a collision probability may be performed to ensure the safety of the driving path information.

For example, whether a collision occurs may be determined while following points contained in the various driving path information is generated by the driving path generation network in a similar way to a real vehicle.

If driving along a portion of the driving path information output by the driving path generation network indicates that a collision is expected, a new set of driving path information that follows a Gaussian distribution may be generated based on corresponding driving path information.

Furthermore, among collision-free driving path information, the driving path information with the lowest cost may be selected/mapped before driving.

For example, the cost may be calculated as follows.

$$Cost = ( \frac{1}{{N}_{t e s t}} ) * {\sum }_{n = 0}^{{N}_{t e s t}} {‖ NetTrajn - Trajn ‖}_{2} \qquad [ Equation 1 ]$$

In this case, Net Traj is driving path information generated by a policy of the driving path generation network, and Traj is the i-th collision-free driving path information.

In the lane change scenario, a straight driving path that maintains the current deviation may be generated if the driving path information is in a direction where a lane change is not possible, even though the driving path is lowest in cost.

If, in the lane change scenario, a collision occurs in all of the generated driving paths, driving path information that return to the original lane may be generated.

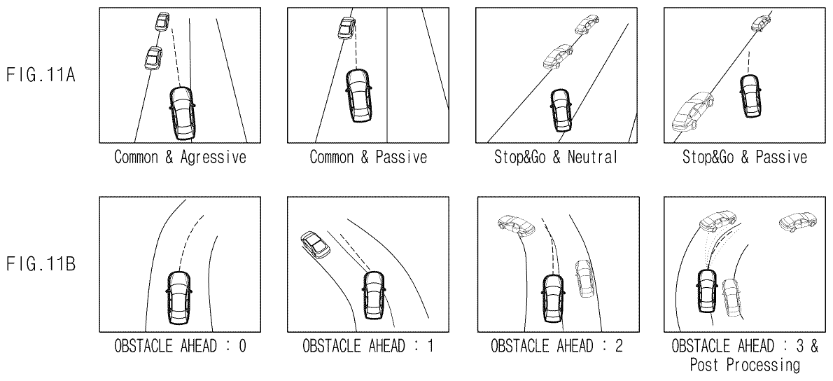

FIGS. 11A and 11B are diagrams schematically illustrating driving path information output by a driving path generation network trained according to a training method disclosed herein.

Referring first to FIG. 11A, which illustrates driving path information generated for the lane change scenario, it may be seen that there are: (i) driving path information generated by the driving path generation network such that a host vehicle is able to change lanes without temporal stop while taking into account an aggressive nearby vehicle (common); (ii) driving path information generated by the driving path generation network such that the host vehicle is able to change lanes without stop while taking into account a passive nearby vehicle (common); (iii) driving path information generated by the driving path generation network such that the host vehicle is able to temporarily stop and then change lanes while taking into account a neutral (aggressive) nearby vehicle; and (iv) driving path information generated by the driving path generation network such that the host vehicle is able to temporarily stop and then change lanes considering a passive nearby vehicles (Stop&Go).

Further, referring to FIG. 11B, which illustrates driving path information generated for the free space driving scenario, it may be seen that there is driving path information generated by the driving path generation network to enable the vehicle to drive considering a situation where there are between zero and three obstacles in front of the host vehicle.

According to the present disclosure, the driving path generation network may be trained based on reinforcement learning to quickly improve the performance of the driving path generation network by using various first driving path information generated and sampled based on a Gaussian random path in the early phase of training. In the later phase of training, an appropriate driving path for autonomous driving of the host vehicle may be quickly generated through a process of advancing (fine-tuning) the performance of the driving path generation network (i.e., a training process classified into hard and soft exploration) using the second driving path information output by the driving path generation network.

Table 3 below shows reduction in computation cycle of the driving path generation network trained according to the training method of the present disclosure. Table 4 shows a collision rate if driving is performed according to the driving path information generated by the driving path generation network trained according to the training method of the present disclosure.

For reference, test has been performed 4000 times for each test scenario, and the results of Table 3 and Table 4 have been derived using 40 seeds.

TABLE 3

| | Lane change | | Free space driving | |
|---|---|---|---|---|
| | scenario | | scenario | |
| Minimum computation cycle | 4.834 | ms | 4.311 | ms |
| Maximum computation cycle | 20.973 | ms | 23.021 | ms |
| Mean computation cycle | 6.213 | ms | 5.587 | ms |

For reference, it may be seen from Table 3 that the mean computation cycle for both the lane change scenario and the free space driving scenario is 5.9 ms, which is a very short computation cycle.

TABLE 4

| | Lane change | Lane change | |
|---|---|---|---|
| | scenario (there | scenario (there | |
| | are two nearby | are three nearby | Free space |
| | vehicles on target | vehicles on target | driving |
| | lane) | lane) | scenario |
| Collision rate | 0% | 0% | 0% |
| after post- | | | |
| processing is | | | |
| performed | | | |
| Collision rate | 0% | 0.05% | 0.1% |
| after post- | | | |
| processing is not | | | |
| performed | | | |

As it may be seen from Table 4, in both the lane change scenario and the free space driving scenario, the collision rate of 0% is achieved if post-processing has been performed.

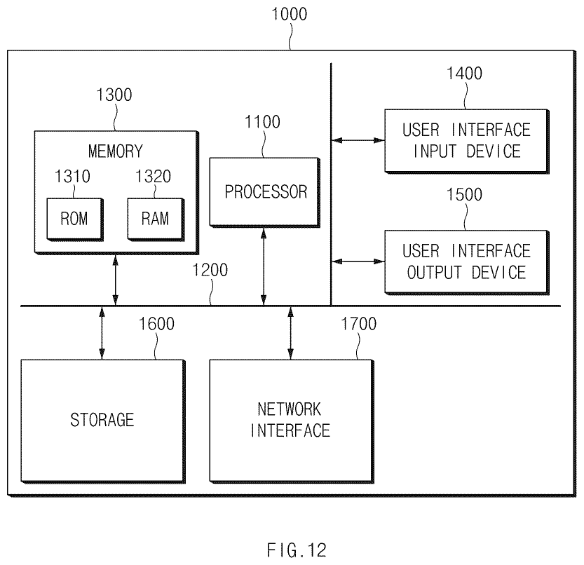

FIG. 12 is a diagram illustrating a computing system related to a vehicle control method and device according to an embodiment of the present disclosure.

Referring to FIG. 12, a computing system 1000 for the vehicle control method and the vehicle control device according to the embodiment of the present disclosure may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the embodiments disclosed herein may be embodied directly in hardware, a software module executed by the processor 1100, or a combination thereof. The software module may reside on a storage medium (i.e., the memory 1300 or the storage 1600), such as a RAM 1320, a flash memory, a ROM 1310, an EPROM, an EEPROM, a register, a hard disk, a removable disk, and a CD-ROM.

The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description merely illustrates the technical idea of the present disclosure. Various modifications and variations may be made without departing from the essential characteristics of the present disclosure by those having ordinary skill in the art to which the present disclosure pertains.

The embodiments described herein may be implemented with hardware components and software components or a combination of the hardware components and the software components. For example, the apparatus, method, + and components described in the embodiments may be implemented using a general-purpose or special purpose computers, such as a processor, a controller and an arithmetic logic unit (ALU), a digital signal processor, a microcomputer, a field programmable array (FPGA), a programmable logic unit (PLU), a microprocessor or any other device capable of executing and responding to instructions. The processing device may run an operating system (OS) and a software application that runs on the OS. The processing device also may access, store, manipulate, process, and create data in response to execution of the software. For convenience of understanding, one processing device is described as being used, but those having ordinary skill in the art should appreciate that the processing device includes a plurality of processing elements or multiple types of processing elements. For example, the processing device may include multiple processors or a single processor and a single controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by a computer readable recording medium.

The above-described methods may be embodied in the form of program instructions that may be executed by various computer means and recorded on the computer-readable medium. The computer-readable medium may include program instructions, data files, data structures, or the like, singly or in combination. The program instructions recorded on the medium may be those specially designed and constructed for the purposes of the inventive concept, or program instructions may be well-known and available to those having ordinary skill in the computer software arts. Examples of computer readable recording media include magnetic media, such as hard disks, floppy disks and magnetic tape, optical media such as CD-ROMs, DVDs, and magnetic disks such as floppy disks, magneto-optical media, and hardware devices specifically configured to store and execute program instructions, such as ROM, RAM, flash memory, and the like. Examples of program instructions include not only machine code generated by a compiler, but also high-level language code that may be executed by a computer using an interpreter or the like.

The hardware device described above may be configured to operate as one or a plurality of software modules to perform the operations of the present disclosure, and vice versa.

Although the technical concepts have been described by the limited embodiments and the drawings as described above, various modifications and variations are possible to those having ordinary skill in the art from the above description. For example, the described techniques may be performed in a different order than the described method. Alternatively, components of the described systems, structures, devices, circuits, etc. may be combined or combined in a different form than the described method. Alternatively, other components, or even if replaced or substituted by equivalents, an appropriate result may be achieved.

Therefore, other implementations, other embodiments, and equivalents to the claims are within the scope of the following claims.

Therefore, the embodiments of the present disclosure are provided to explain the spirit and scope of the present disclosure but not to limit them, so that the spirit and scope of the present disclosure is not limited by the embodiments. The scope of protection of the present disclosure should be interpreted by the following claims, and all technical: ideas within the scope equivalent thereto should be construed as being included in the scope of the present disclosure.

According to the embodiments of present disclosure, it is possible to provide a vehicle control method and a vehicle control device.

According to the embodiments of present disclosure, it is possible to provide a training method and a training device for generating a driving path and to provide a testing method and a testing device using the same.

According to the embodiments of present disclosure, it is possible to provide a training method and a training device for generating a driving path based on reinforcement learning and to provide a testing method and a testing device using the same.

According to the embodiments of present disclosure, it is possible to provide a training method and a training device for generating a driving path in response to various driving scenarios and to provide a testing method and a testing device using the same.

According to the embodiments of present disclosure, it is possible to provide a training method and a training device for generating an accurate driving path within a short calculation time in a vehicle with limited computational resources and to provide a test method and a test device using the same.

In addition, various effects may be provided that are directly or indirectly understood through the disclosure.

Hereinabove, although the present disclosure has been described with reference to embodiments and the accompanying drawings, the present disclosure is not limited thereto. The embodiments of the present disclosure may be variously modified and altered by those having ordinary skill in the art to which the present disclosure pertains without departing from the spirit and scope of the present disclosure claimed in the following claims.

What is claimed is:

1. A method for controlling an autonomous vehicle, the method comprising:
in response to a determination that a plurality of first driving path information corresponding to first state information is acquired,
calculating a first reward corresponding to at least a portion of the first driving path information based on a result of performing a driving simulation according to the first driving path information, and
training a driving path generation network based on at least a portion of the first reward;
in response to a determination that second state information is acquired,
generating at least one second driving path information corresponding to the second state information through the driving path generation network,
calculating a second reward corresponding to at least a portion of the second driving path information based on a result of performing a driving simulation according to the second driving path information, and
training the driving path generation network based on at least a portion of the second reward; and
in response to a determination that test state information is acquired,
generating test driving path information corresponding to the test state information through the trained driving path generation network, and
controlling the autonomous vehicle using the test driving path information.

2. The method of claim 1, wherein calculating the first reward includes:
generating the first driving path information corresponding to the first state information based on road information on a Frenet frame;
generating first mapping driving path information by mapping the first driving path information to a Cartesian frame; and
calculating the first reward corresponding to first driving path information on the Frenet frame that has been mapped to the first mapping driving path information on the Cartesian frame based on a result of performing a driving simulation according to the first mapping driving path information.

3. The method of claim 2, wherein calculating the first reward includes mapping the first driving path information to the Cartesian frame by referring to curvature information contained in the road information.

4. The method of claim 1, wherein calculating the second reward includes generating, by the driving path generation network, an amount of change in position of a point corresponding to each of a plurality of time steps included in a unit time period as the second driving path information.

5. The method of claim 1, wherein calculating the second reward includes:
generating the second driving path information corresponding to the second state information based on road information on a Frenet frame;
generating second mapping driving path information by mapping the second driving path information to a Cartesian frame; and
calculating the second reward corresponding to second driving path information on the Frenet frame that has been mapped to the second mapping driving path information on the Cartesian frame based on a result of performing a driving simulation according to the second mapping driving path information.

6. The method of claim 5, wherein calculating the second reward includes mapping the second driving path information to the Cartesian frame by referring to curvature information contained in the road information.

7. The method of claim 1, wherein:
the driving path generation network includes
a classifier configured to determine a driving scenario corresponding to a current driving situation of a host vehicle among a first driving scenario to an n-th driving scenario based on at least a portion of input data including the first state information and the second state information, and
a first driving path generation network to an n-th driving path generation network respectively corresponding to the first driving scenario to the n-th driving scenario; and
the method further includes
determining, by the classifier, a k-th driving scenario corresponding to the current driving situation of the host vehicle based on at least a portion of the input data, and
training a k-th driving path generation network corresponding to a k-th driving scenario based on a (1_k)-th reward according to (1_k)-th driving path information corresponding to the k-th driving scenario among the first driving path information, and based on a (2_k)-th reward according to (2_k)-th driving path information corresponding to the k-th driving scenario among the second driving path information.

8. The method of claim 1, wherein at least a portion of the first driving path information is a Gaussian random path.

9. A device for controlling an autonomous vehicle, the device comprising:
a memory configured to store computer-executable instructions; and
at least one processor configured to access the memory and execute the computer-executable instructions,
wherein the at least one processor is configured to, in response to a determination that a plurality of first driving path information corresponding to first state information is acquired,
calculate a first reward corresponding to at least a portion of the first driving path information based on a result of performing a driving simulation according to the first driving path information, and
train the driving path generation network based on at least a portion of the first reward,
wherein, in response to a determination that second state information is acquired,
generate at least one second driving path information corresponding to the second state information through the driving path generation network,
calculate a second reward corresponding to at least a portion of the second driving path information based on a result of performing a driving simulation according to the second driving path information, and
train a driving path generation network based on at least a portion of the second reward, and
wherein, in response to a determination that test state information is acquired,
generate test driving path information corresponding to the test state information through the trained driving path generation network, and
control the autonomous vehicle using the test driving path information.

10. The device of claim 9, wherein the at least one processor is configured to:
generate the first driving path information corresponding to the first state information based on road information on a Frenet frame;
generate first mapping driving path information by mapping the first driving path information to a Cartesian frame; and
calculate the first reward corresponding to first driving path information on the Frenet frame that has been mapped to the first mapping driving path information on the Cartesian frame based on a result of performing a driving simulation according to the first mapping driving path information.

11. The device of claim 10, wherein the at least one processor is configured to map the first driving path information to the Cartesian frame by referring to curvature information contained in the road information.

12. The device of claim 9, wherein the at least one processor is configured to generate, through the driving path generation network, an amount of change in position of a point corresponding to each of a plurality of time steps included in a unit time period as the second driving path information.

13. The device of claim 9, wherein the at least one processor is configured to:
generate the second driving path information corresponding to the second state information based on road information on a Frenet frame;
generate second mapping driving path information by mapping the second driving path information to a Cartesian frame; and
calculate the second reward corresponding to second driving path information on the Frenet frame that has been mapped to the second mapping driving path information on the Cartesian frame based on a result of performing a driving simulation according to the second mapping driving path information.

14. The device of claim 13, wherein the at least one processor is configured to map the second driving path information to the Cartesian frame by referring to curvature information contained in the road information.

15. The device of claim 9, wherein:
the driving path generation network includes
a classifier configured to determine a driving scenario corresponding to a current driving situation of a host vehicle among a first driving scenario to an n-th driving scenario based on at least a portion of input data including the first state information and the second state information, and
a first driving path generation network to an n-th driving path generation network respectively corresponding to the first driving scenario to the n-th driving scenario; and
the at least one processor is configured to
determine, through the classifier, a k-th driving scenario corresponding to the current driving situation of the host vehicle based on at least a portion of the input data, and
train a k-th driving path generation network corresponding to the k-th driving scenario based on a (1_k)-th reward according to (1_k)-th driving path information corresponding to the k-th driving scenario among the first driving path information, and based on a (2_k)-th reward according to (2_k)-th driving path information corresponding to the k-th driving scenario among the second driving path information.

16. The device of claim 9, wherein at least a portion of the first driving path information is a Gaussian random path.
